(19) United States
(12) Patent Application Publication
(10) Pub. No.: US 2014/0172630 A1
(43) Pub. Date: Jun. 19, 2014

(54) SOCIAL MEDIA INTERFACE FOR USE WITH A GLOBAL SHOPPING CART

(71) Applicant: MASTERCARD INTERNATIONAL INCORPORATED, (US)

(72) Inventors: Jennifer Dogin, Mamaroneck, NY (US); Brian Maw, Norwalk, CT (US)

(73) Assignee: MASTERCARD INTERNATIONAL INCORPORATED, Purchase, NY (US)

(21) Appl. No.: 13/828,978

(22) Filed: Mar. 14, 2013

Related U.S. Application Data
(60) Provisional application No. 61/737,556, filed on Dec. 14, 2012.
(60) Provisional application No. 61/750,905, filed on Jan. 10, 2013.
(60) Provisional application No. 61/763,755, filed on Feb. 12, 2013.

(51) Int. Cl. G06Q 50/00

(52) U.S. Cl. CPC G06Q 50/01; G06Q 30/0633
USPC 705/26.8

(57) ABSTRACT

A social media interface operates with a global shopping cart. While the global shopping cart establishes tasks, categories or themes for one or more particular purposes or projects, the social media interface includes functions for a social contact to receive an invitation to participate in one or more particular tasks, projects or themes of the global shopping cart, and to accept the invitation. Additional functions of the social media interface allow social contacts to comment on one or more parts of the particular tasks, projects or themes. Comments can be accepted and used, or rejected, by the user of the global shopping cart.

### RELATED APPLICATIONS

This application claims priority in U.S. provisional application Ser. No. 61/737,556 filed on Dec. 14, 2012, U.S. provisional application Ser. No. 61/750,905 filed on Jan. 10, 2013, and U.S. provisional application Ser. No. 61/763,755 filed on Feb. 12, 2013. All three of these U.S. provisional applications are incorporated herein by reference in their entirety.

### BACKGROUND OF THE DISCLOSURE

1. Field of the Disclosure

The present disclosure relates to electronic shopping. More particularly, the present disclosure relates to a social media interface for allowing the sharing of information and the participation in tasks and projects, both proposed and ongoing, in a global shopping cart.

2. Description of the Related Art

The multitude of shopping choices available on-line and at points of sale has made maintaining a track of purchases a relatively complex task. It is sometimes very difficult to keep track and organize all of the data concerning purchases made by an individual or a family over a period of time. Further, some tasks or projects are undertaken that may extend for a year or more. For example, it may take over a year to plan a wedding or a construction project, such as adding one or more rooms to a house.

During the course of these tasks or projects, it is desirable to have an organized way to construct a list of items that must be purchased or services that must be obtained, and to keep track of what has been purchased, and what needs to be purchased. Often, after a project has been completed, it is desirable to have information on the project so that, if necessary, replacement items can be purchased, warrantees can be exercised, and additional services of the type utilized, can be obtained. Generally, during the course of several years, the information required to purchase replacement components, exercise warrantees, or find the required services may no longer be available due to the loss of paper records and receipts.

For some projects, such as a wedding, it is desirable that certain aspects be shared with anyone authorized by the owner. For example, a bridal registry should be available on-line. Furnishings for a new addition to a house can be made available for comment and/or ranking by anyone authorized by the owner, who may have excellent ideas for alternative furnishings.

When a global shopping cart is established, there is a need for a social media interface to allow family and friends, to the extent desired, to participate in proposed or ongoing tasks or projects. There is a further need for conducting searches for information relevant to specific tasks or projects on pages of social media web sites. There is also a need to efficiently organize and display for use information that is discovered during such search or searches.

### SUMMARY OF THE DISCLOSURE

There is provided a social media interface system and/or a method for operating a social media interface that can interact with an online global shopping cart.

There is also provided a social media interface and/or a method for operating a social media interface that interacts with an online global shopping cart concerning tasks, categories or themes for projects in which purchases have been or are to be made.

There is further provided a social media interface and/or a method for operating a social media interface that interacts with an online global shopping cart to provide goods and services from multiple sources, including sources outside the country in which the global shopping cart is established.

There is still further provided a display for organizing and clustering data for ease of retrieval and use of the social media interface.

The present disclosure provides a computer readable non-transitory storage medium storing instructions of a computer program that when executed by a computer system results in performance of steps for creating and operating a social media interface.

### BRIEF DESCRIPTION OF THE DRAWINGS

FIG. 1 is block diagram of system for implementing an exemplary embodiment of the present disclosure.

FIG. 2 is a diagram illustrating the components of an exemplary global shopping cart for use with the present disclosure.

FIG. 3 is a diagram showing the relationship of the social media interface of the present disclosure to the global shopping cart and web sites of interest.

FIG. 4 is a diagram illustrating the components of an exemplary social media API or interface that can be used with the global shopping cart of FIG. 2.

FIG. 5 illustrates sample API fields for use in the social media interface of FIG. 3.

FIG. 6 is a flow chart illustrating the use of the social media interface disclosed herein.

FIG. 7 illustrates the manner in which data is organized for ease of use.

A component or a feature that is common to more than one figure is indicated with the same reference number in each figure.

### DESCRIPTION OF THE PREFERRED EMBODIMENT

The following terms are used herein.

An entity is the owner of a global shopping cart. Entities may include, but are not limited to, a person, business, consortium of businesses (such as, by way of example, the businesses in a local shopping mall or businesses selling the same lines of products in different locations), school, club, fraternity or sorority, an organization having members in a particular trade or profession, sales representative for particular products, charity, not-for-profit organization, labor union, local government, government agency, or political party.

A task is something that is done on a one time or repetitive basis. A task may be a continuous endeavor, such as, for example, controlling inventory or office supplies. A task may be a project, such as, for example, planning a wedding, which can take a long period of time, approximately a year or longer, but is nonetheless contemplated to be a single event. A task can include a project, such as, for example, remodeling or redecorating a home or office, that can take several years.

An operator is an individual or an organization that operates a server that hosts one or more global shopping carts. An operator can be a payment network operator, such as MasterCard Incorporated, another business, or a consortium of businesses. However, it will be understood that there are other possible operators and types of global shopping carts, such as, for example, a mobile telephone company. There can be a mobile, global shopping cart that is analogous to a so-called m-commerce (mobile commerce) site. The mobile shopping cart is designed to operate with the resources available on a mobile device, such as, for example, a smart phone.

A user of a global shopping cart can be the entity or owner, or anyone authorized by the owner, including a merchant, to use the global shopping cart. For example, if the owner is an individual, that owner may authorize his or her family members (generally a spouse or older child) or a particular merchant to use the global shopping cart. If the owner is a business, certain employees or other businesses in cooperation with the owner's business can be authorized to use the global shopping cart 300.

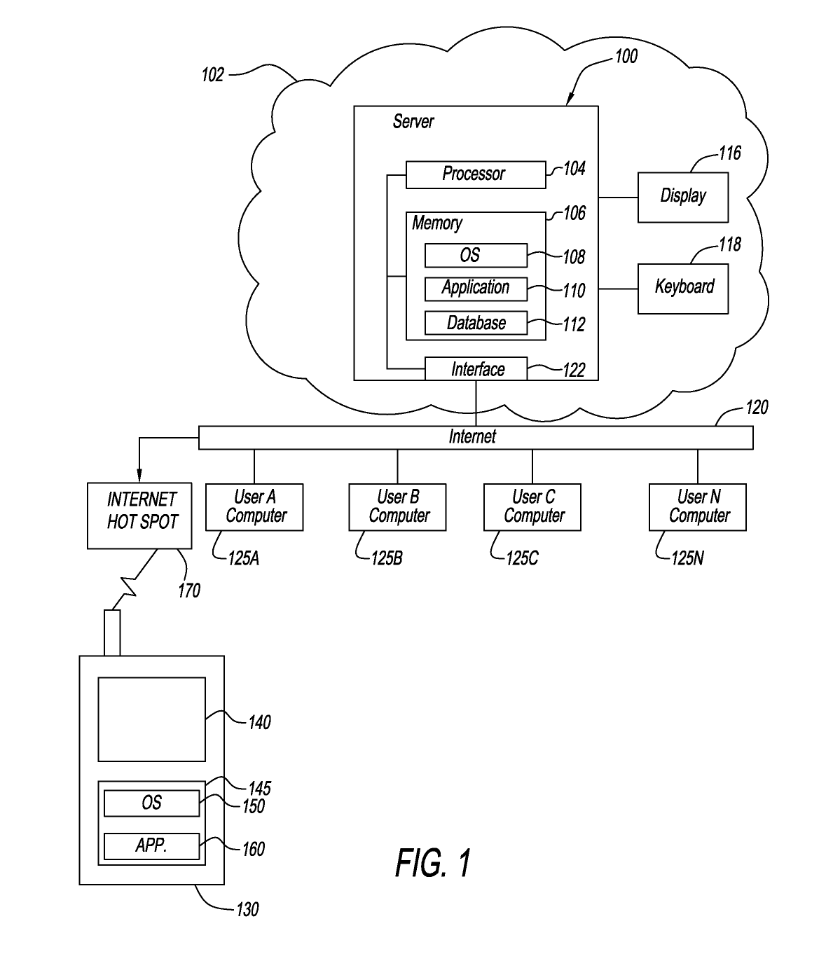

Referring to the drawings and, in particular, FIG. 1, a web site is operated on a server generally referred to by reference numeral 100. The server 100 is in the cloud 102. Server 100 is connected to the Internet 120 by an interface 122. Server 100 includes a data processor 104 and a memory 106. Server 100 is connected to a display 116 and a keyboard 118. It will be understood that server 100 may have a number of other peripheral devices customarily found in any computer, such as, for example, a CD or DVD drive (not shown), for placing programs on server 100 or devices associated with or connected to the server for creating physical records of data processed by server 100.

Memory 106 has a memory portion 108 for an operating system (“OS”) for server 100, a memory portion 110 for one or more application programs, including one that is the subject of this disclosure, and a memory portion 112 used as the storage for a database, as described below.

The data of the database stored in memory portion 112 is stored in any type of memory, including a hard drive, flash memory, CD, RAM, or any other suitable memory, with provisions for suitable backup as known in the art.

Access computers 125A, 125B, 125C to 125N can access server 100 via a connection to the Internet 120, as described below.

The operator of server 100 may provide rules as to who can establish a global shopping cart. For example, a holder of a credit card issued by an issuing bank of the operator may establish a global shopping cart at no cost. There may be a modest fee for others who authenticate their identity, on a one time, monthly or yearly basis. If there is a minimum amount of purchasing activity initiated via the global shopping cart, the fee can be waived.

A mobile communication device 130, such as, for example, and not by way of limitation, a telephone, has a display 140 and a memory 145 for storing an operating system 150 and a series of applications or applets therein. The series of applications or applets include an applet or application program (hereinafter an application) 160. Mobile communication device 130 can access server 100 via an Internet connected Wi-Fi hot spot 170 (or by any telephone network, such as a 3G or 4G system, on which mobile communication device 130 communicates) by using application 160. Application 160 may include MasterPass™ capability so that Internet purchases are quickly and easily completed. It is preferable that application 160 be a relatively thin application. Further, application 160 is preferably not particularly complex so that operation on a mobile device, including those devices without great computing resources, is facilitated.

A cart or global shopping cart 300 in accordance with the disclosed embodiment is accessed by a user using a computer 125A, 125B, 125C to 125N, or a mobile communication device 130. Purchases can be made by a user or consumer using an access computer 125A, 125B, 125C to 125N, or by using mobile communication device 130. However, it will be understood that web site 100 may be accessed from a home or business computer, a personal digital assistant, a game console, a home appliance such as, for example, a smart refrigerator, any other Internet connected communication device, such as, a tablet or other mobile device (for example, an iPad® or an Ultrabook), or any stationary device, such as, for example, a kiosk.

The global shopping cart 300, once established, remains in effect for the life of the person who established it, and in some instances beyond, and also allows purchases to be made internationally. The global shopping cart 300, or the information contained therein, can, for example, become an asset of an estate. This may be especially applicable as between partners or spouses who often share at least some other joint assets. The global shopping cart 300 allows purchases to be made internationally. Aspects of global shopping cart 300 can be shared with others, such as family, friend, and colleague including a preferred merchant, to allow for their participation in long term projects. Thus, a merchant or a merchant entity has the possibility of access to and serving, not only the creator of the global shopping cart 300, but also family, friends, invitees and anyone else, including a merchant, who is given access to the global shopping cart 300. The merchant entity may be, for example, a personal shopper for the individual who owns the global shopping cart 300. Other entities may be granted access to global shopping cart 300 to perform selected functions, as the owner of the global shopping cart 300 determines. The granted access will be managed by the owner of global shopping cart 300 by controlling the profile of the entity and with due regard for the privacy of the owner's data.

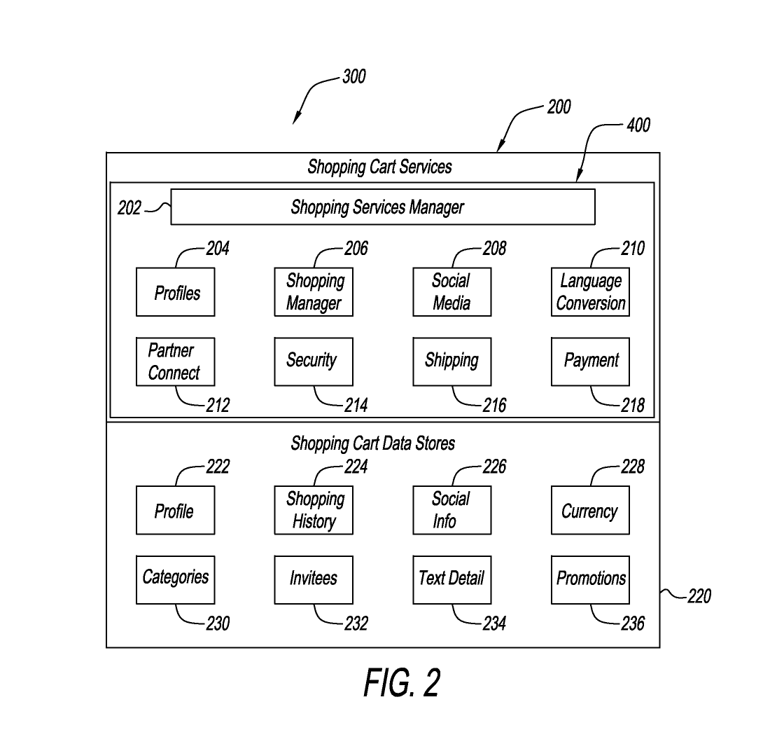

Referring to FIG. 2, shopping cart services 200 include a shopping cart manager 202 that manages the shopping cart services, such as, for example, profiles 204 of shopping behavior, a shopping search function 206, social media 208, language conversion 210, partner connect 212, security 214, shipping 216, and payment 218. Profiles 204 of shopping behavior include, for example, attributes, such as, where shopping is done, whether it is on-line or in person, and amounts spent in various categories. Profiles 204 also include a user profile with the characteristics of the user, such as, for example, age range, income range, gender, and town of residence. Thus, a merchant's access to this information is valuable in establishing the merchant′ products, services and inventory.

Shopping search function or manager 206 provides a shopping search function that includes electronic storage for items that have been selected for purchase, and information concerning the vendor, the price, a photograph, a video clip, lead time until shipment and other similar information. The shopping search manager 206 can make the purchases, via on-line or via one or more appropriate web sites, can store the information needed to otherwise make the purchase, such as telephone information, or the exact location of a local store or product outlet.

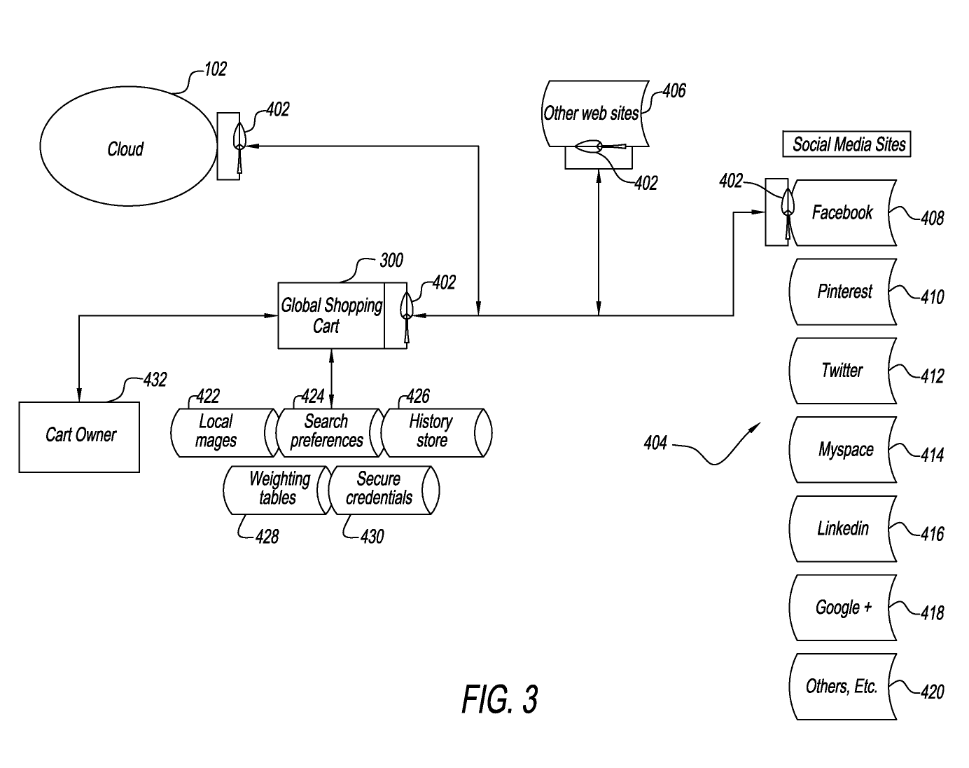

Social media interface 208 supplies selected and non-confidential information to a selected social media web site that the user of global shopping cart 300 has joined such as for example, Facebook®. Alternatively, an interface to a social media web site developed specifically for global shopping cart 300 can be used. In either case, the social media interface 208 will allow others, most preferably friends and family, but possibly a merchant, to participate in a project by offering suggestions, suggesting alternatives, and possibly even buying items, such as gifts, for the owner of global shopping cart 300. Social media interface 208, connections to global shopping cart, details of function and details of operation are discussed below with respect to FIGS. 3 to 7.

Access to global shopping cart 300 can include screening of data. A private area or page may be established, for example, for viewing by an invitee desired by the owner. The invitee can log on with, for example, a user name, password, and the telephone number of their personal mobile telephone. Security may be enhanced by using any security protocol that is currently used such as, for example, a personal phrase, a security question, an image, an e-mail address, a real time SMS PIN received from the global shopping cart 300, that must be entered to gain access, or any other security device or protocol.

Language conversion module 210 assists in international shopping activities. The word content of web pages can be converted to the language of choice of the global shopping cart owner.

Partner connect function 212 is also provided. A partner is anyone other than the owner of global shopping cart 300, and thus could be a merchant or a merchant's designee, such as, for example, a personal shopper. Typically, a partner is a merchant or contractor who provides goods or services in connection with a category directed to a particular theme or project. Limited access is granted to that information required to complete a theme or project, or if the contractor is managing that theme or project, all relevant information. A contractor may send a message similar to a friend request. In response to that message, in some cases, or at the beginning of a relationship, read-only rights to the global shopping cart 300 may be provided. Later, the contractor may be given the right to provide comments. If the contractor is hired, full rights, including the right to make purchases to complete a project, can be provided. This may be done by providing a screen, or portion of a screen, where appropriate boxes may be checked to provide different rights, or check marks removed to withdraw those rights. If there is any change in the task or category, an alert may be provided to the user of global shopping cart 300.

Security module 214 provides varying levels of security for global shopping cart 300. Security module 214 can include both secure and non-secure areas for various themes. A completely secure area is only accessible by the owner of shopping cart 300. Other areas or non-secure areas can be defined for joint access. Still other areas may be defined for shared or communal access. Each area can have a different level of security to which invitees may be granted access. For example, a secure area may include a wedding or home remodeling theme. An unsecured area may be one that is open for donations, such as, for example, for a local school event or a favorite charity.

An invitee to a portion of global shopping cart 300 must register to gain access to the cart. Also, a registration is preferably required to assist in controlling unauthorized access by spammers and/or those seeking to commit fraud. Once registered, an invitee can review items in the area or areas of the carts to which the invitee has been granted access. Thus, this is beneficial to a merchant for many reasons besides the particular task. In accordance with the privileges granted, the invitee may be able to view one or more items, add items, change items, remove items, and links or pictures, and such other analogous additions, deletions or changes. The access of an invitee may be terminated or limited by the owner of global shopping cart 300 at any time.

In general, the cart owner will control all aspects of security over the entire life of the owner or for the entire life of the global shopping cart 300. Major life changes for an individual, such as marriage, divorce, cohabitation, moving to another country, or death of a spouse or significant other, could potentially have a great impact on the configuration of the cart and the access rights to various areas. Analogous concerns may apply to an owner that is a business or other organization.

One or more global shopping carts 300 can be established by the various entities defined above. For example, a non-profit entity may wish to establish a shared or communal cart that any person can access to add a generic donation item and then enable payment for that item to be made. An entity could also post a wish list of items needed to accomplish its goals with the hope that others will provide the item, based on items already on hand, or based on a link to the item that is added to the cart so that it can be purchased for charity. An alert function can be provided so that a global shopping cart owner can opt-in to receive alerts for charities they have identified.

An entire cart or parts of a cart may be moved or copied from one global shopping cart 300 to another global shopping cart. This may be appropriate where global shopping carts 300 are established by entities, such as two or more businesses and a merger there between occurs. Where a home is being remodeled, access to that portion of the cart can be granted to the owner of another cart to use as a template. One advantage to the recipient carts is that access could be granted to the invitee list for that portion of the cart, which may include professional contacts, such as remodeling companies, city or county permit contacts, or other contacts pertinent to accomplishing the task for which that portion of the cart was created.

A shared space or communal area of global shopping cart 300 can be configured to be open to anyone. A cart owner may create an area for purchase of a used automobile and within that area provide some criteria for the item to be purchased, such as make, model, accessories, mileage requirements, pictures illustrating the desired color, and any special features. A price range for the item that states how much the cart owner is willing to pay can also be specified. Anyone accessing the shared space can search the network of carts having a shared or communal area for the listed item, and offer a response or provide a link, pictures or contact details to propose an item for purchase by the cart owner. The cart owner may accept or decline such proposals. As used herein, purchase means some reciprocation in value whether it be an equal value or agreed upon value. Thus, purchase can be in the form that includes, but is not limited to, money, barter, gift certificate and point program.

Shipping module 216 manages and keeps track of items that have been ordered and their location in the shipping network, as advised by the various carriers. Item tracking numbers are followed. Alerts provided by the shippers can be forwarded to the owner of the cart by various “push technologies”, including, but not limited to, e-mail, voicemail, and instant messenger. Alternatively, the owner of the cart, or a person who has been granted access to the cart, can access the cart and bring up a page or an API on the accessing device, and check current status. The shipping module may also be used to compute or keep track of shipping costs, which for purchases from distant vendors, may make a difference as to whether a particular purchase is made, or whether it is made from that vendor.

Payment module 218 provides for payment for any items purchased in global shopping cart 300. Payment module 218 may have the characteristics of a digital wallet, and may allow access to a plurality of accounts or funding sources. When purchases are made, acknowledgements of or receipts for the purchases may be managed by payment module 218. In the case of international purchases, currency computations, as described below, and shipping costs, as described above, may also be managed.

Data required for the operation of global shopping cart 300 is stored in shopping cart stores 220. The data in the cart stores are stored in a format that makes it available for or translatable to other database technologies that may be developed in the future. This is of particular importance since the amount of data that must be retained and managed will be very large over the lifetime of global shopping cart 300. There are various forms and formats for storing the data in shopping cart stores 220. A preferred format can be an open source format. However, the various storage modules for the different kinds of data that are stored, are described below.

Profile or profile store 222 stores the data for the profile or profiles created at 204. As noted above, a user profile with the characteristics of the user, such as, for example, age range, income range, gender, and town of residence, can be stored. If global shopping cart 300 is shared, the profiles of more than one person can be stored, such as that of family members authorized to use global shopping cart 300. A dollar limit on the spending of a minor child may also be stored as part of a profile. Shopping behavior, such as where shopping is done, whether it is on-line or in person, and amounts spent in various categories, can also be components of a user profile.

Shopping history store 224 includes data or information on the items that have actually been purchased. Such data includes, but is not limited to, SKU number, price paid, where purchased, when purchased, method of purchase, source of funds, and type of purchase. This data may be used to as part of the formulation of profile 204 stored in profile store 222.

Social information store 226 includes information used by social media interface 208. Social media interface 208 interfaces with social media platforms, and information derived from social media web sites. This information may be used to access existing social media, or a social media site specifically intended to and designed for interaction with global shopping cart 300.

Currency store 228 contains a database of currency exchange rates, as well as currency exchange fees charged by the various sources of funds used by payment module 218. These rates and fees can be updated on any periodic (for example, daily at 5:00 PM local time) basis by accessing various pertinent web sites and by downloading the information contained therein. A real time data service may be used to calculate or recalculate the exchange rates at the time a purchase is made. These rates and fees, as well as shipping costs, are of material assistance to anyone using global shopping cart 300 in evaluating the actual cost of an item, and in making a decision whether the item should be purchased from a particular source or, perhaps, whether it should be purchased.

Categories store 230 is used to store the items purchased by kind or type. This storage can be based in part on SKU numbers, or can be stored in categories as created by the owner of the cart. In one embodiment, the creation of categories by the owner can be based on the themes established, such as remodeling of a home or a wedding. The storage by categories or themes enables the owner to track the allocation of funds for various purposes.

Invitees store 232 stores the security data mentioned that is obtained when invitees register for access to a portion of global shopping cart 300. In particular, the information required to establish the various levels of security is stored.

Text detail store 234 is used to store textual information. Textual information includes, but is not limited to notes, one or more pictures, photographs, and links to web sites, audio and video files relating to items selected for inclusion in global shopping cart 300, and items suggested for inclusion by invitees. If the space required for the linked items is included, text detail store 234 can be quite large in terms of the storage resources required for all information.

Security measures may be put in place to assure that material that is uploaded to global shopping cart 300 is not done for illegal, immoral or other prohibited purposes. For example, filters can be used to block material that is pornographic, directed to illegal substances, or to other selected illegal activity, such as, for example, money laundering, terrorism, smuggling and making purchases with stolen credit card numbers. This may be accomplished in a variety of ways, including prohibiting transfer of data from certain web sites, or from web sites in countries where fraud is more likely, scanning content before it is posted, and checking for unusual activity, in a manner similar to that used for fraud alerts on credit cards. Analytics triggers can be used that would indicate suspicious shopping cart activity. Such an analytic trigger may be based on, for example, the number of people who have wide access to one or more sections of an individual person's cart. For example, if the purpose of a task is to plan a wedding, then twenty or perhaps no more than thirty people should be involved. If there are too many invitees, it is almost a certainty that proper security has not been maintained. Other indications that something improper may be happening include, but are not limited to, spending that does not fit the nature of the task or that is outside the usual spending patterns of the owner of the global shopping cart. Other examples of suspicious activity include transactions by the same individual originating in multiple geographic regions, and multiple sequential transactions with one merchant. Other problematic situations, while not illegal, include the posting of spam. This situation may prove distracting to invitees or cause them to be fearful of possible fraud, and discourage use of the global shopping cart. Anti-spam software, available from major software providers, can be used in conjunction with the global shopping cart to block access by known sources of spam. If there is inappropriate activity, or an obvious security breach, shopping cart activity can be suspended until the issue has been resolved.

Promotions store 236 stores data relating to various sales promotions or discounts provided by vendors of goods in global shopping cart 300. The existence and nature of these items may be periodically updated by accessing the web sites of vendors of items in global shopping cart 300 (whether or not a purchase has been made) by interfacing to the shopping cart owner's e-mail to look for promotions or discounts, or by manually entering data at an appropriate screen based on information received elsewhere, such as by mail. Advantageously, the dates of expiration of these promotions or discounts can also be stored so that an alert can be sent to the owner of global shopping cart 300, any desired time prior to expiration, such as a day or week prior to expiration. This alert gives the owner an opportunity to decide whether to make the purchase at a time that takes advantage of the promotion or discount, or to wait anticipating a better promotion or discount may later be available.

FIG. 3 is a diagram showing the relationship of the social media interface to the global shopping cart 300 and to web sites of interest. The arrangement of FIG. 3 differs from that illustrated in FIG. 1 in that the global shopping cart 300 could be in the cloud, but could be located on a server that is not “in the cloud” 102.

Of importance to the social media interface is a social media application program interface (API) 402 that represents hardware (including a network connection path) and software that can be present at a plurality of locations to permit global shopping cart 300 to access the cloud 102, social media sites, shown generally as 404, and other web sites 406. Social media sites 404 can include, but are not limited to, Facebook 408, Pinterest 410, Twitter 412, Myspace 414, LinkedIn 416, Google+ 418, and others 420.

Social media API 402 accesses a number of data stores that may be associated with global shopping cart 300, with social media API 402, or with both. These data stores include local images 422, search preferences 424, history store 426, weighting tables 428, and secure credentials 430.

Social media API 402 uses a push/pull approach to information sharing, searching, and retrieval. Invitations to share information or experiences can be pushed out to friends or others to join a cart, or to open a section of a cart for sharing, searching, attaching, and retrieval. Information sharing is a key element of cart growth and social interaction. Information from any social media site 404 can be accessed and shared according to the specification for social media API 402. Each social media site 404 can be searched independently and concurrently to ensure results are returned in a timely manner.

An owner 432 of global shopping cart 300 can define data within their cart that is accessible to any other person. Each information element can be tagged with a reference that will allow it to be viewed, copied, or shared. The social media API 402 will only retrieve or share information that has been previously identified for this purpose.

Invitations can be sent to others to provide comments on items that are presently being searched, in the midst of research, or in the process of retrieval or sharing. This feature allows for mentoring or commentary to help guide the selection and purchase process.

A typical search may include looking up valuable information, such as planning a vacation, and desiring to learn about preferred hotels, restaurants, site seeing, excursions, theatre, shopping, etc. for an upcoming trip to, for example, Paris. The cart owner could select various search criteria including, but not limited to, accessing a list of all social networking sites, searching the cloud for information posted from friends or travel experts, accessing news feeds, blogs, magazines, other web sites, and setting criteria such as locating information that is current within the last twelve (12) months. Based on the search criteria and a relevance weighting, all of this information could be retrieved to the cart owner for review and potential inclusion into a cart.

If a cart owner 432 searched and located a specific segment of a cart that contained a trip manifest to a desired destination, the cart owner 432 could simply attach the trip details into their own cart and use the entries within it to subsequently plan their own getaway.

A relevance factor or weighting can be assigned (1 to 100) by the cart owner 432 to define the importance to any specific detail that is capable of being included in the search criteria, and stored in weighing table 428. For example, cart owner 432 could assign the highest relevance or weighting factor to travel professionals who write about their travel experience, followed by travel web sites, followed by close friends, followed by next level friends. Two identically weighted items will return search results in the order of based on the criteria set by the cart owner.

The relevance factors stored in weighting tables 428 can be easily updated by the cart owner. Specific search criteria can be saved in history store 426, and thus can be recalled for future searches. For example, travel searches may include specific travel web sites, friends who travel frequently and their connected social media sites. When a cart owner 432 wishes to review travel options, the cart owner 432 may pull up the template saved with all the search criteria pre-allocated and simply apply it to the new search.

The notion of a ring of friends is used to define the relationship between the cart owner and the person closest to them. For example, a close friend, or first person connection includes someone in the first ring. A next level friend of that person would be included in the second ring, and so forth. A singular person can be weighted individually by a relevance factor.

The search results from a travel search would, therefore, include the highest relevant items first in the search list followed by the next highest, and so forth. More than one link may be returned and concatenated in a list to define a single search result target. For example, if the highest search relevance in a travel search was the travel professional, the search result may return a link to one of his carts to be cloned, a link to his/her pictures of the trip on Facebook, and a link to his/her tweets from the trip. All of these items would be bundled into one search result in the list, or grouping of search items to be reviewed. The reviewer of this group of items can keep or discard items at will.

All search results, groupings and links can be saved for any length of time, as specified by cart owner 432 in the cart owner's preferences.

The search process may also tap sites, such as LinkedIn, to pull in a grouping of job opportunities depending on the criteria set by cart owner 432.

Notifications from Facebook and other social media alerts can be included in the search results, or shared with other friends.

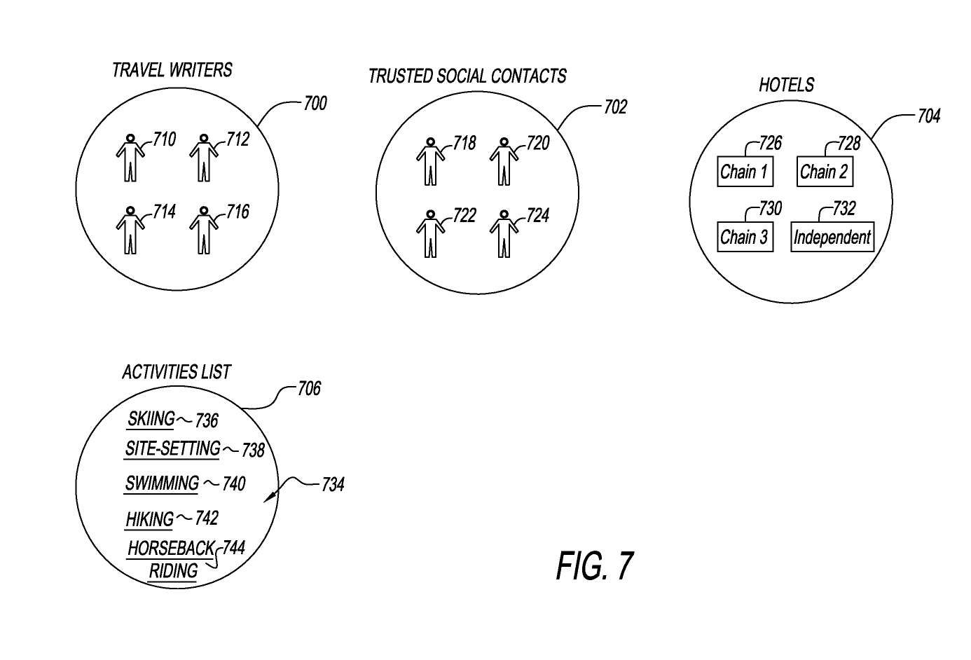

The default search conducted if no criteria and relevance factors have been identified would simply default to Google, Bing, Yahoo, or whatever search engine is specified as a default. The results of these search engines are highly typical and customary for simple search capability. However, those results will not have the advantages of the grouping of search results as described below with respect to FIG. 7.

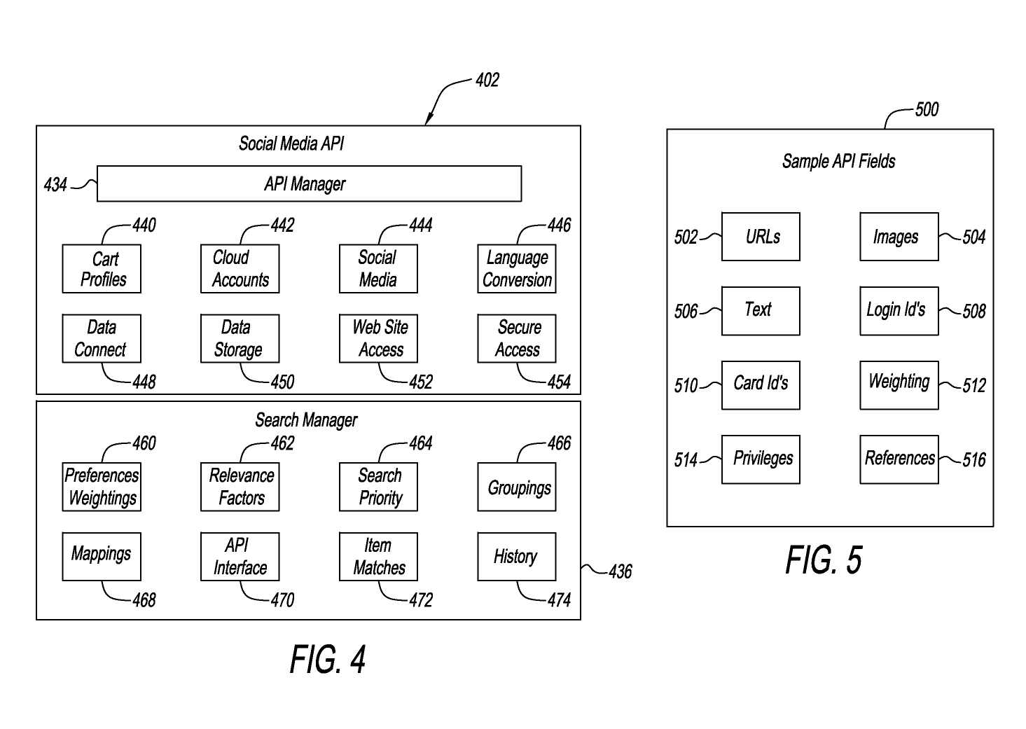

FIG. 4 illustrates components of an exemplary social media API or interface 402 that can be used with global shopping cart 300 of FIG. 2. Social media API 402 includes an API manager 434 and a search manager 436. API manager 434 includes separate items that can be accessed and available from global shopping cart 300. For example, API manager 434 includes: cart profiles 440 that may be the same as, or analogous to, profiles 204 of global shopping cart 300; cloud accounts 442; a social media database 444 (which may be the same or analogous to social media 208 of shopping cart 300); a language conversion function 446 (which may be the same as or analogous to language conversion 210); a data connect function 448; a data storage 450 which can be that of global shopping cart 300; a web site access function 452; and a web site secure access function 454.

Web site access function 452 can include public, private and other APIs. Secure access function 454 provides varying levels of security for the social media API 402. Secure access function 454 can include both secure and non-secure areas for various themes. Each area can have a different level of security to which invitees may be granted access. An invitee preferably must register to gain access. Also, a registration is preferably required to assist in controlling unauthorized access by spammers and/or those seeking to commit fraud. Once registered, an invitee can search items in the area or areas to which the invitee has been granted access. The access of an invitee may be terminated or limited by the owner of global shopping cart 300 at any time.

Search manager 436 includes a number of functions, such as: a preference weightings 460 for storing weightings in weightings tables 428 shown in FIG. 3; relevance factors 462 for specifying the relevance of various sources of information; search priority 464 for specifying a preferred order of web sites to be searched; groupings 466 for specifying factors to be used for grouping search results; mappings 468 for specifying how to map search results to particular groupings for display; an API interface 470 for interfacing the social media API 402 to other components as illustrated in FIG. 3; item matches 472 that matches items to particular product specifications; and history 474 that stores history information in history store 426 shown in FIG. 3. An event log may be associated with history 474, with the log stored in history store 426.

Referring to FIG. 5, a screen 500 is used to enter data for the social media API 402. URL's of web sites are entered in field 502. At field 504, images or video clips that may be associated with a web site or other entries are entered. Text, or file names for files that have text information associated with a web site or other entries, are entered at field 506. Login ID's are entered in field 508. Global shopping cart identification information (“Cart Id's”) is entered at field 510. Weighting or weighting factors are entered at field 512. Privileges for invitees are entered at field 514, or can be accessed by references to profiles 204 of FIG. 2. References for where information can be found are entered at field 516. Field 516 includes any information as to where data or information came from including, but not limited to, tracking history of data and information.

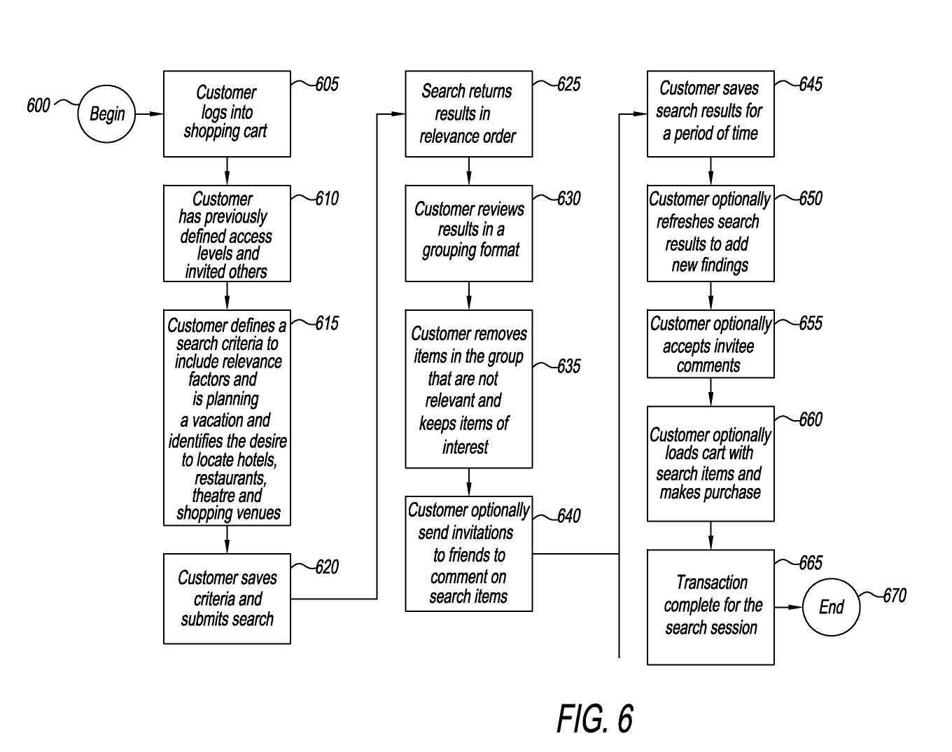

Referring to FIG. 6, social media API 402 is accessed by a user begins at 600. This access can be with a browser, or a thin application when API 402 is placed on a mobile device. On a device with sufficient computing power, such as a desktop computer, the social media API 402 can be a more complex client program. In either case, it is desirable, to the extent possible, to store as much information locally as possible, to avoid extensive or bulk downloads of data from the global shopping cart 300, other sources in the cloud 102 or on the worldwide web, every time the social media API 402 is used. In particular, this is the situation if there is no desire on the part of the user of global shopping cart 300 to preserve the data on a long term basis, for example, when the data is associated with a trip that will not be repeated.

At 605, the user or customer logs into the global shopping cart 300. At 610, the previously defined access levels have been defined or may be defined when new invitees are designated, if required. At 615, the customer defines the search criteria to include relevance factors. For example, if the customer is planning a vacation, the desire to locate hotels restaurants theaters and shopping venues is entered. At 620, the customer saves the search criteria and submits the search. At 625, search results are provided in the order of relevance. At 630, the customer reviews the results in a grouping format as discussed below. At 635, the customer removes items in the various groups that are not relevant and designates items of interest to be kept. At 640, the customer optionally sends invitations to friends to comment on items located in the search. This may be done in the manner discussed above with respect to global shopping cart 300 or via social media websites 404 shown in FIG. 3. At 645, the customer saves the search results for some designated period of time. The customer may also direct that particular search results are not to be deleted unless such direction is specifically provided. At 650, the customer optionally refreshes the search results to add new findings. Generally this occurs if the search is run another time. At 655, the customer may at his option accept invitee comments. At 660, the customer optionally loads the cart with search items and makes one or more purchases. At 665, the transaction is complete for the search session and the session is ended when the customer logs out at 670.

There are several advantages to providing a social media contact with access to the task, category or theme established in global shopping cart 300. The contact can be made aware of the general nature of the project, and may have information or perspective to contribute. For example, the contact may have recently gone on vacation to the same geographic area, or may have recently done similar remodeling on her home. With that knowledge, the contact can make suggestions for successful completion of a task including but not limited to, comments on the quality or suitability of listed goods, suggestions for alternative items, leaving a message to advise of the dates of availability of a promotion or reward, and recommendations for contractors to assist in the completion of the project. These suggestions can include any item that any invitee may contribute and, in addition to being in text format, can be a link to a web page, an image, an audio file, and/or a video file. Thus, trusted contacts may be active participants in the project. Contacts and invitees can be vetted to be sure that they are legitimate.

Global shopping cart 300 and social media API 402 can be configured to provide access logs and various reports to the cart owner, such as, for example, a list of items purchased for a remodel that may be of tax significance at a later time as adding to the tax basis of the house or may be of significance when an item must be repaired or replaced. In a small business, an office manager or a tax accountant may run reports. This may be of tax significance at a later time, such as, adding to the tax basis of the house, or may be of significance when an item must be repaired or replaced. Some items can be designated as tax deductible for the current tax year and, thus, for inclusion with annual tax filings. A report of invitee activity can be generated. The report can be reviewed, as desired, to determine which invitee or social contact made significant contributions, whether by way of suggestions that were adopted or by way of purchasing items for the cart owner as gifts. Reports summarizing daily, weekly, monthly and yearly spending may be generated. These reports can be sorted by merchant category, product category or SKU type, method of payment, currency used, country of purchase, date of purchase, amount spent per purchase, gift recipient, or in almost any other manner for which data has been supplied. The running of a report is an event that is logged with a record kept of the person who ordered or ran the report. Such reports are periodically given or immediately copied to the owner of the global shopping cart.

In view of global shopping cart 300 and social media API 402 being accessible by an application on most, if not all, smart telephones, any image, video, audio and other data present on the smart phone can be uploaded to the appropriate task, category or theme of global shopping cart 300 in real time. Some images, videos and sounds may be of special significance to the owner of global shopping cart 300 and will be available for a lifetime and, perhaps, beyond, to serve as reminders of particular significant events, such as vacations or social gatherings. Access can be granted to select family members and friends so that they can experience the sights and sounds of a joyous occasion or an adventure. For an item purchased with global shopping cart 300, images, videos or sounds can be included with the item at the time of purchase or at a later time. For example, if a grandparent purchases a pet from a merchant, the grandchild can upload a special thank you video to be shared with those who have access to global shopping cart 300. Later generated items, such as a video of the child playing with the pet, can be uploaded.

When global shopping cart 300 or social media API 402 is accessed by a mobile device that has a GPS receiver, the location of the mobile device can become a basis for selecting the manner in which some of the functions described above operate. For example, a default currency, shipping methods and carriers, and browsing for items to be added for purchase, can be directed based on the current location of the mobile device.

One or more web sites may be established by shopping cart 300 for each task, category or theme established. Generic templates for a web page or a portion of a web page as well as customization tools can be provided. The global shopping cart 300 may have a standard or universal home page. A suite of tools (possibly accessible from a drop down menu), including a set of very simple and easy to use tools, as well as more complex tools that may require knowledge of how to write code in a language such as, for example, HTML, can be provided. The owner can use the tools most appropriate to his or her skill level to establish and maintain the page or pages on the web site. Options may include various widgets that can be pulled from a menu and dropped at screen locations satisfactory to the user.

A dashboard display can be used to manage various functions and categories. A list of all categories can be displayed on the dashboard. A blog area or page may be established with a forum section. A social area may be used to make friends and to invite friends to join and access a task, category or theme. Also, people can be asked to become friends on a social media web site. Alerts received from various sources can be linked to icons on the dashboard so that the user of global shopping cart 300 or social media API 402 is made aware of the alert, by for example, flashing of the icon or a change in its color. An alert can also be provided by the use of audio, including playing a particular sound, tone or music, or the sounding of particular words. An alert can still also be provided in video form including the playing of a portion of a movie or other video clip.

An opt-in function for alerts can be provided by global shopping cart 300 and social media API 402 for various categories or themes. For example, cat enthusiasts may be interested in receiving alerts relating to cats, such as cat food, cat grooming, and cat health products and services. A list of forums or relevant sites may be provided. Also, a box, checked or unchecked, for each site to determine whether alerts are received when some new activity occurs on a site. This may apply to a product or a group of products. The owner or user of global shopping cart 300 or social media API 402 will thus know when special promotions or advantageous sales terms are available.

FIG. 7 illustrates a recommend data display format in which data is organized and clustered for ease of review and use. While FIG. 7 illustrates the organization of data for the planning of a trip, it will be understood that it is an example, and that many other specific arrangements are contemplated for other uses.

FIG. 7 avoids the difficulty of reviewing a long list of the search output of many search engines, and attempting to find precisely the desired information. References to data are clustered within a series of circles 700, 702, 704 and 706. While these circles are illustrated, it will be understood that any geometric shape, such as, for example, polygon, oval, or a shape having both circular and curved elements, could be used. Generally, the geometric figure should be a closed figure with links inside of the figure. In FIG. 7, each circle presents a different kind or type of data.

Circle 700 is associated with travel writers. A search is conducted based on the preferences weightings 460 stored in weighting tables 428, writings on blogs or other Internet sites, and information copied from social media pages or from global shopping carts to which access has been granted. Information relevant to the proposed trip from, for example, the most trusted four or five travel writers may be stored for later reference. The information is accessed by clicking on one of photographic representations 710, 712, 714, and 716, within circle 700, representing the travel writer who authored the information.

In the same manner, circle 702 contains pictures 718, 720, 722, 724, from, for example, social media sites, of people who are considered by the user of social media API 402 to be experienced travelers and who are trusted in terms of their reliability. Again, a search is conducted based on the preferences weightings 460 stored in weighting tables 428 for information relevant to the proposed trip. The information is accessed by clicking on a picture within circle 702 that represents the social media contact who authored the information, selected it for inclusion on a social media web page, or has it within a global shopping cart 300 (or portion thereof) to which access has been granted.

Circle 704 can be used to represent hotels where the user may wish to stay, at one or more locations during the course of the trip. Photos of the hotel at the travel location or a symbol representative of a first hotel chain 726, a second hotel chain 728, a third hotel chain 730, and an independent hotel 732 are placed with circle 704. Again, a search is conducted based on the preferences weightings 460 stored in weighting tables 428 for information relevant to the proposed location for the trip. The information is accessed by clicking on a photograph or symbol within circle 704.

Circle 706 may contain an activities list 734 in which the traveler or travelers may wish to engage during the course of the trip. These activities include, for example, skiing 736, site-seeing 738, swimming 740, hiking 742, and horseback riding 744.

Clicking on one of the activities in the list 734 will bring up another display screen similar to that of FIG. 7, in which each of the facilities providing that activity is listed. The format can be the same as that of FIG. 7. For example, if skiing 736 is selected, the display may have circles or other geometric shapes for cross country skiing, beginner skiing, downhill skiing, and ski racing. Photographs, icons or other symbols within each circle represent places at the travel location or locations where the activity can be conducted. Clicking on one of these items can provide detailed information concerning that facility.

Thus the display in FIG. 7, and others displays that can be accessed via FIG. 7, that may be similar in structure. Also, they provide an excellent way to cluster and organize data obtained, at least in part, by using social media API 402. Further, the arrangement of the circles or other geometric figures representative of the clusters can be placed on the display in a perceived order of importance. For example, for those who are accustomed to languages where one reads from left to right, generally the most significant cluster will be in the upper left side of the display, and the clusters of decreasing significance will be placed at successive positions to the right of the cluster having the most significant data. For languages where one reads from right to left, the most significant cluster can be placed in the upper right corner, and the clusters of decreasing significance will be placed at successive positions to the left of the cluster having the most significant data. Variations in the order of placement of the clusters are appropriate for other languages, such as where one reads from the top to the bottom of a page.

It will be understood that the various aspects of the present disclosure may be embodied in a computer readable non-transitory storage medium storing instructions of a computer program that when executed by a computer system results in performance of steps of the method described herein. Such storage media may include any of those mentioned in the description above.

It will be understood that, in general, it is necessary to log on to a social media web site in order to access information from contacts such as friends on that site. However, a user of a global shopping cart can log on and access a social media site, and can also, from the social media web site, use a global shopping cart that user has been authorized for. This permits the user to access other social media sites.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A social media interface for use with a global shopping cart, comprising:
a storage medium having thereon computer instructions for implementing a plurality of functions for interaction with social media web sites and the global shopping cart; and
a processor for executing the computer instructions to provide functions including:
an invitation function for transmitting an invitation to join a task being performed using the global shopping cart, to a member of a social media web site; and
a receiving function for receiving an acceptance of the invitation from the member.

2. The social media interface of claim 1, wherein the storage medium includes computer instructions for searching, on the social media web site, for information relevant to the task.

3. The social media interface of claim 2, wherein the storage medium includes computer instructions for searching web sites other than the social media web site.

4. The social media interface of claim 2, wherein the storage medium includes computer instructions for selecting for storage and retrieval information found during a search.

5. The social media interface of claim 2, wherein the storage medium includes computer instructions for storing search preferences for use during a search.

6. The social media interface of claim 5, wherein the storage medium includes thereon instructions for storing weighting values for the search preferences.

7. The social media interface of claim 2, wherein the storage medium includes computer instructions for searching portions of global shopping carts to which access by the social media interface has been granted.

8. The social media interface of claim 1, wherein the storage medium includes instructions for displaying information relevant to the task by organizing the information into clusters, and wherein each cluster is displayed in a geometric figure.

9. The social media interface of claim 8, wherein the geometric figure is selected from the group consisting of a circle, an oval, a polygon, and a geometric figure made up of curved and straight portions.

10. The social media interface of claim 1, wherein the storage medium includes instructions for permitting an invitee to upload at least one data selected from the group consisting of a comment on the task, a comment on an item selected for purchase for the task, a link to a web page, an image, an audio file, and a video file.

11. A method for operating a social media interface for interaction with a global shopping cart, comprising:
executing on a processor instructions for:
transmitting from the social media interface to a member of a social media web site an invitation to join in a task established on the global shopping cart; and
receiving an acceptance of the invitation from the member.

12. The method of claim 11, further comprising searching, on the social media web site, for information relevant to the task.

13. The method of claim 12, further comprising searching web sites other than social media web sites, for information relevant to the task.

14. The method of claim 12, further comprising selecting for storage and retrieval information found during a search.

15. The method of claim 12, further comprising storing search preferences for use during a search.

16. The method of claim 15, further comprising storing weighting values for the search preferences.

17. The method of claim 11, further comprising displaying information relevant to the task by organizing the information into clusters, and wherein each cluster is displayed within a geometric figure.

18. The method of claim 17, wherein the geometric figure is selected from the group consisting of a circle, an oval, a polygon and a geometric figure made up of curved and straight portions.

19. The method of claim 11, further comprising searching portions of global shopping carts to which access by the social media interface has been granted.

20. A computer readable non-transitory storage medium storing instructions of a program that when executed by a computer system results in performance of steps for creating and operating a social media interface, the social media interface interacting with a global shopping cart having one or more tasks to be completed are defined, the instructions of the program providing functions of the social media interface that comprise:
transmitting from the social media interface to a member of a social media web site an invitation to join in a task established on the global shopping cart; and
receiving an acceptance of the invitation from the member.

21. The computer readable non-transitory storage medium of claim 20, further comprising instructions for a computer system to search, on the social media web site, for information relevant to the one or more tasks.
